(19) United States
(12) Patent Application Publication
(10) Pub. No.: US 2026/0158982 A1
(43) Pub. Date: Jun. 11, 2026

(54) INFANT CAR SEAT BASE WITH ROTATING TRAY

(71) Applicant: Evenflo Company, Inc., Miamisburg, OH (US)

(72) Inventors: Joel William WENNERSTROM, Roslindale, MA (US); Charles H. KEEGAN, Miamisburg, OH (US); Bryan Ray ADAMS, Beavercreek, OH (US); Jessica POPELKA, Charlotte, NC (US); Xiaogang HUAN, Kunshan (CN)

(21) Appl. No.: 18/976,020

(22) Filed: Dec. 10, 2024

(51) Int. Cl. B60N 2/90; B60N 2/28; B60N 2/68

(52) U.S. Cl. CPC B60N 2/933; B60N 2/2821; B60N 2/2869; B60N 2/688

(57) ABSTRACT

An assembly is provided for securing an infant car seat within an automobile. The assembly comprises a base having; a front, a back and a top area extending between the front and the back, the top area defining a channel. The assembly further comprises an arm pivotally coupled to the base. The arm is pivotal between a first position with the arm pivoted away from the top area allowing open access to the channel and a second position with the arm pivoted adjacent the top area preventing open access to the channel. The assembly further comprises a tray rotatably coupled to a top surface of the arm, such that the tray is rotatable with respect to the arm, the tray having a top surface adapted to receive an infant car seat.

### CROSS-REFERENCE TO RELATED APPLICATIONS

This application is related to U.S. Patent Application No. ______, entitled “CAR SEAT ARM LOCK INDICATOR,” Attorney Docket No. 42842.423529, filed on even date herewith.

### TECHNICAL FIELD

The present disclosure generally relates to an assembly to hold a car seat that includes a rotating tray on the strong arm of the base.

### BACKGROUND

In the United States, child car seats are required by law and recommended for children of certain ages or sizes. There are many types of car seats available for purchase. Infant car seats recommended for children under age 1 are typically rear-facing. Many car seats include a base that is belted or tethered into the car and a seat that may latch into the base. The base may be secured to the car using the seat belt. An arm is pivotally coupled to the base (sometimes called a “strong arm”). The arm is pivoted away from the base to allow the base to be secured using the seat belt. The arm is then pivoted down and is secured in the down position, and secured over the seat belt. The car seat is then secured to the base. It would be helpful to be able to turn, or re-orient, the car seat on the base to make it easier to load and unload the child.

### BRIEF DESCRIPTION OF THE DRAWINGS

The drawings described herein are for illustrative purposes only, are schematic in nature, and are intended to be exemplary rather than to limit the scope of the disclosure.

FIG. 1 is a perspective view of an assembly used as part of a child transport system.

FIG. 2 is a perspective view of the assembly of FIG. 1, but showing the arm pivoted to a closed position and the assembly in a transport position.

FIG. 3 is a view similar to FIG. 2, but showing the tray rotated with respect to the arm and the assembly outside of the transport position.

FIG. 4 is an enlarged, partial perspective view of the arm and tray.

FIG. 5 is a view similar to FIG. 4, shown in an exploded view, with the top of the tray hidden from view.

FIG. 6 is a cross-section along line 6-6 of FIG. 2.

FIG. 7 is an exploded view of portions of the arm and tray.

### DETAILED DESCRIPTION

In an example, an assembly is provided for securing a car seat within an automobile. The assembly comprises a base having a front, a back and a top area extending between the front and the back. The top area defines a channel configured to receive a seat belt to secure the base within the automobile. The assembly further comprises an arm pivotally coupled to the base. The arm is pivotal between a first position with the arm pivoted away from the top area allowing open access to the channel and a second position with the arm pivoted adjacent the top area preventing open access to the channel. The assembly further comprises a tray rotatably coupled to a top surface of the arm, such that the tray is rotatable with respect to the arm, the tray having a top surface adapted to receive an infant car seat. The rotation of the tray on the arm allows easier access to the child in the car seat, such as placing the child within the car seat, or taking the child out of the car seat.

The above features and advantages, and other features and advantages of the present teachings are readily apparent from the following detailed description of the modes for carrying out the present teachings when taken in connection with the accompanying drawings.

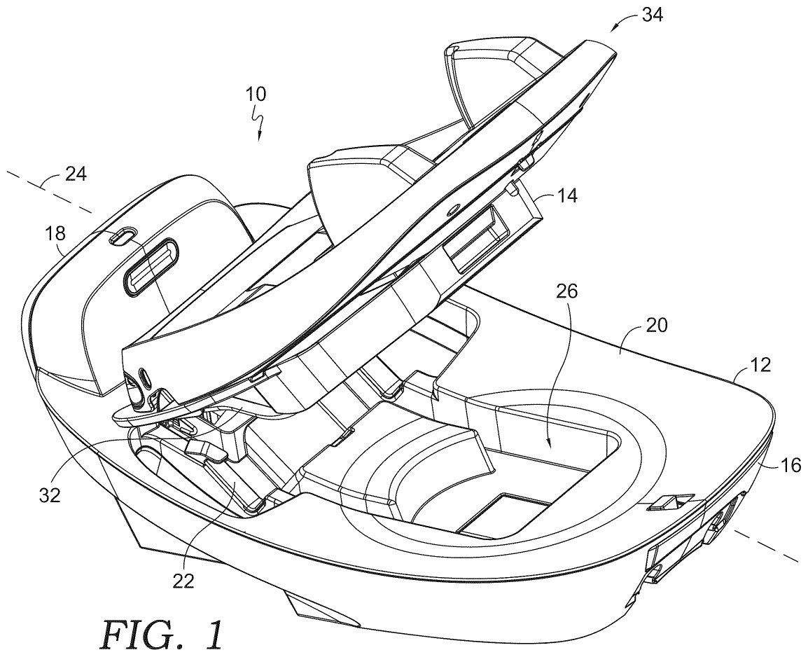

Referring to the drawings, wherein like reference numbers refer to like components, FIGS. 1-7 depict an assembly 10 for securing a car seat to the automobile. As used herein and as will be appreciated by those skilled in the art, the term “car seat” encompasses car seats, safety seats, restraints, boosters, and the like for children, infants, and toddlers and the like. The assembly 10, in some aspects, includes a base 12 and an arm 14 (sometimes called a “strong arm”) pivotally coupled to the base 12. The base 12 has a front 16, a back 18, and a top area 20 extending between the front 16 and the back 18. As best seen in FIG. 1, the top area 20 defines a channel 22 that is shaped and sized to accommodate a seat belt of the automobile. In some aspects, the channel 22 is nearer to the back 18 than the front 16 on the base 12. A longitudinal axis 24 can be seen to bisect the base 12 (the longitudinal axis 24 will be used in the description below to describe other features of the assembly 10). As best seen in FIG. 1, the top area 20 also defines a relief area 26.

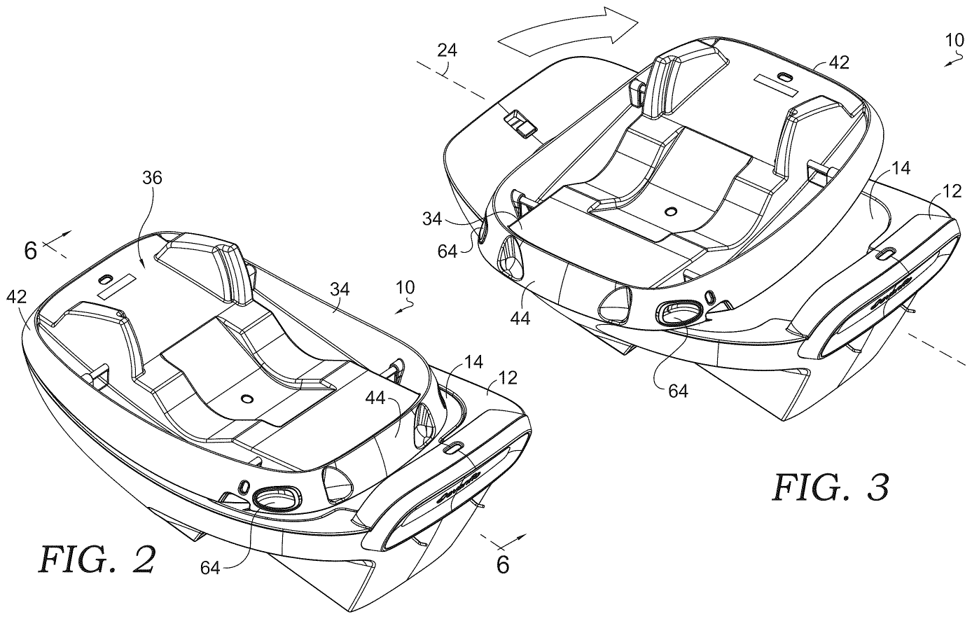

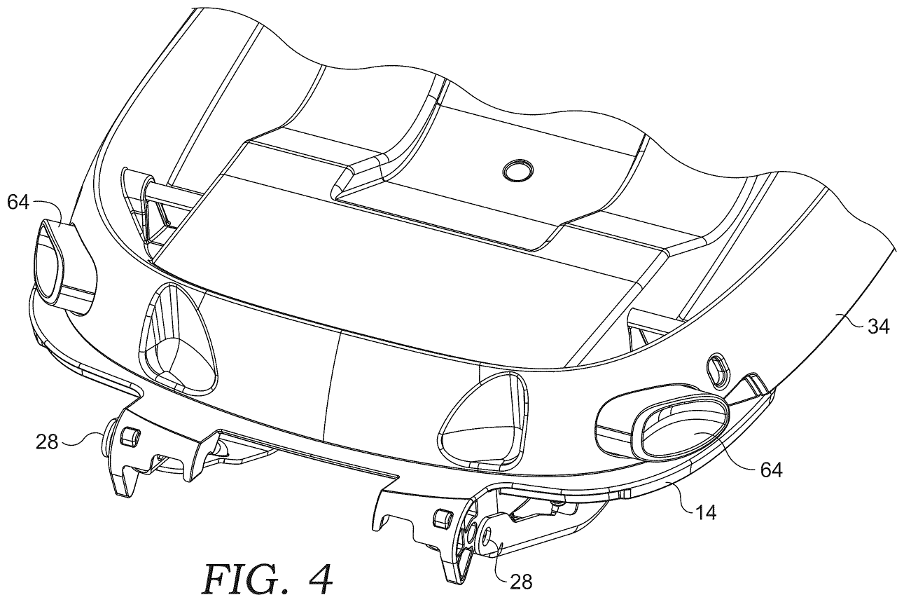

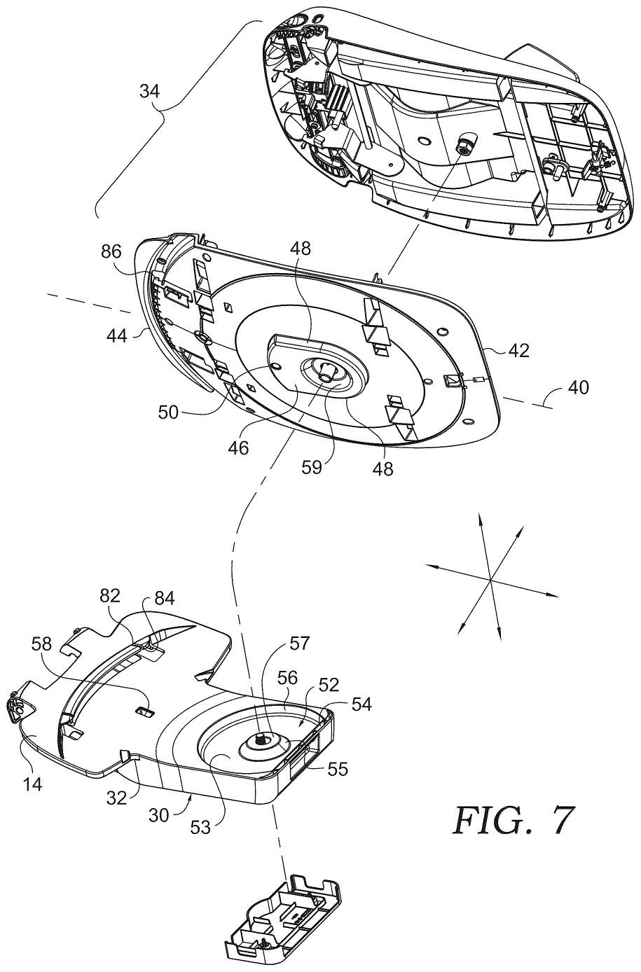

The arm 14 is pivotally coupled to the base 12 at pivot points 28 (labeled in FIG. 4). The arm 14 is pivotal from a first, open position, shown in FIG. 1, with the arm 14 pivoted away from the top area 20 of the base 12, to a second, closed position, shown in FIG. 2, with the arm 14 pivoted down to abut the top area of 20 of the base 12. In the open position, a user can access the top area 20 of the base 12, such as to secure the base to the automobile with a seat belt along channel 22. In the closed position (with the seat belt in place), the assembly 10 is ready to accept a car seat, such as in infant carrier. The arm 14, in some aspects, includes a bottom 30 (as best seen in FIG. 7) with a portion corresponding to the relief area 26 on the base 12. In some aspects, the bottom 30 includes columns 32 that fit within a portion of the relief area 26.

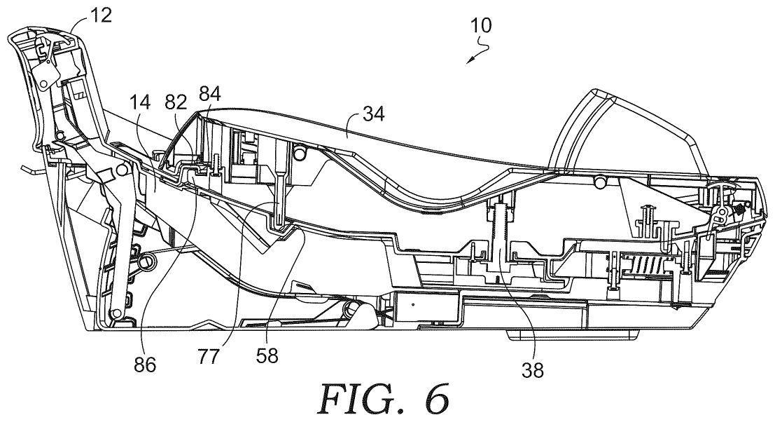

A tray 34 is rotatably coupled to the arm 14. The tray 34 has a top surface 36 that is configured to accept and secure an infant car seat to the tray 34 (and thus to the assembly 10). As best seen in FIG. 6, the tray 34 may be coupled to the arm 14 with a bolt 38 (although other attachment mechanisms could be used). The bolt 38 serves as the rotational axis about which the tray 34 rotates on the arm 14. As seen in FIG. 7, like the base 12, the tray 34 may have a longitudinal axis 40 bisecting the tray 34 and extending from a front 42 of the tray 34 to a back 44 of the tray 34. As best seen in FIG. 7, a hub 46 extends from the bottom of the tray 34. In some aspects, the hub 46 is shaped to have opposed side walls 48 and a round, semi-circular, or circular end wall, shown as round side wall 50 that is oriented toward the back wall 44 when the assembly 10 is in a transport condition. The hub 46 fits within a depression 52 on the top of the arm 14. The depression 52 may have, in some aspects, a front wall 54 and a round side wall 56. As such, the circular end wall 50 is shaped and sized to nest within a perimeter formed by the circular side wall 56. Further, the dimensions of the hub 46 including the circular end wall 50 are shaped and sized to rotationally move while following the perimeter formed by the round side wall 56, based on the rotation of the tray 24 relative to the arm 14.

The hub 46 extends in length (measured from bolt 38 toward the back 44) such that the circular end wall 50 abuts the round side wall 56 of depression 52. This additional surface area enables more contact with the bottom surface(s) of the tray 34, and thus increase the stability to the tray 34 during rotation, particularly when load bearing. Additionally, the upper surface 53 of the depression 52 includes a raised, centralized portion 55 having upward slanting walls and a planar top surface 57. The centralized portion 55 may be centered relative to the bolt 34 and may be round in shape. This centralized portion 55 fits into a recessed pocket 59 that is formed in the lower surface of the hub 46 when stacked. The recessed pocket 59 includes similarly slanted walls that allow the raised portion 55 to nest therein while maintaining a gap sufficient to allow the hub 46 to rotate. Accordingly, the truncated-cone shape of the centralized portion 55 nesting within the hub 46 provides stability (e.g., less or no wobble) to the tray 34 and a smooth rotational motion when the tray 24 is rotated relative to the arm 14, particularly when load bearing.

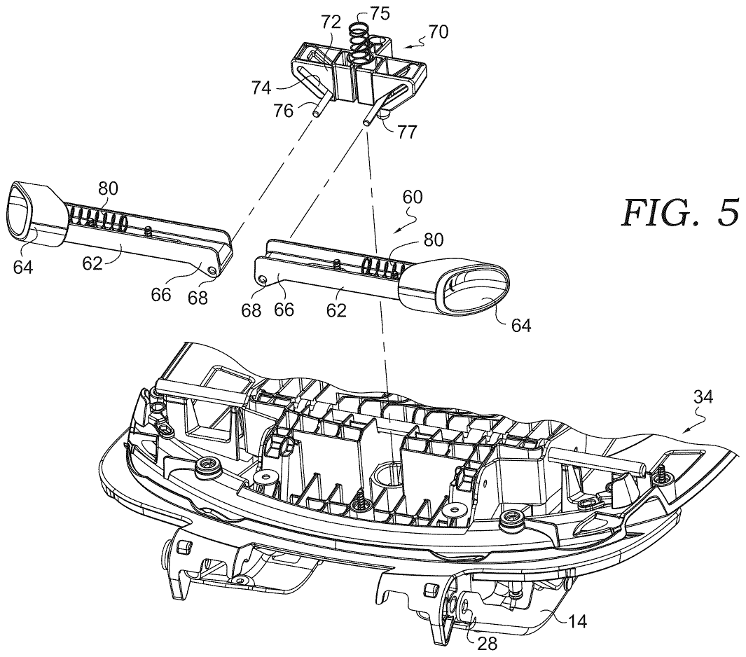

The top of the arm 14 also defines a locking notch 58, as best seen in FIGS. 6 and 7. The locking notch 58 is used to releasably secure the tray 34 in a transport condition, as further described below. Although the locking notch 58 is depicted as a single notch that is positioned as aligning with the longitudinal axis, it will be understood that any quantity of notches and other positions are contemplated. As best seen in FIG. 5, the tray 34 may include, in some aspects, a release mechanism 60. The release mechanism 60 includes a pair of legs 62 that are held within the tray 34. The legs 62 are allowed to move within the tray 34 in a sliding fashion. In some aspects, the tray 34 includes an integral passageway that slidingly holds the legs 62. The outer end of each leg 62 may include a button 64 that protrudes from the outer perimeter of the tray 34. The end of each leg 62 opposite the button 64 includes a coupling section 66 with a through hole 68. The hole 68 is used to couple the leg 62 with a locking pin 70. More specifically, the locking pin 70 has a top section 72, as best seen in FIG. 5. Each side of the top section 72 includes an angled hole 74. The hole 68 and the hole 74 are used to couple the legs 62 to the locking pin 70, such as with a retainer pin 76. The retainer pin 76 extends through the corresponding hole 68 to couple a corresponding leg 62 to the locking pin 70. The locking pin 70 includes a downwardly extending finger 77, as shown in FIG. 6.

When the longitudinal axis 40 of the tray 34 is aligned with the longitudinal axis 24 of the base 12, the finger 77 extends into the locking notch 58, as shown in FIG. 6. In this position, the assembly 10 is in a condition for transport and the tray 34 will not rotate with respect to the arm 14 as the extension of the finger 77 into the locking notch 58 immobilizes the tray 34 to prevent its rotation. If a user desires to rotate the tray 34 with respect to the arm 14 (such as might be desired to place and remove a child from the car seat in place on the tray 34), the user can concurrently press the buttons 64 inwardly, which moves the legs 62 horizontally inward. This horizontal, inward movement moves the retainer pin 76 coupling the coupling section 66 and the top section of the locking pin 70 downwardly along the angled hole 74. Each angled hole 74 is oriented such that an uppermost position is located above and lateral to a lowest position, which is thus located below and medial to the uppermost position within the tray 34. As the retainer pin 76 is translated horizontally inward as a result of the buttons 64 being pressed, the retainer pin 76 slidably moves from the uppermost position to the lowermost potion, and further a spring 75 allows the locking pin 70 to be moved vertically, but biases it downwardly. As such, the horizontal inward motion of legs 62 causes each corresponding retainer pin 76 to move horizontally inward and to move from the uppermost to the lowermost position of each respective angled hole 74, such that the locking pin 70, is pushed upward due to the upper-lateral to lower-medial slant. As such, the horizontal motion of the legs 62 causes the locking pin 70 to move vertically, based on the corresponding retainer pins 76 moving along the angles of the corresponding angled holes 74. For example, each corresponding retainer pin 76 may move horizontally outward as coupled to the legs 62, and may move from the lowermost to the uppermost position of each respective angled hole 74, such that the locking pin 70 moves vertically downward. The upward movement of the locking pin 70 moves the finger 77 out of engagement with the locking notch 58. With the locking pin 70 free of the locking notch 58, the tray 34 can be rotated with respect to the arm 14, as can be seen by comparing FIG. 2 to FIG. 3. While the above-described construction is one way to release the locking pin 70 from the notch 58, other release mechanisms and constructions could also be used.

In some aspects, the legs 62 are biased outwardly, such as with a spring 80, as shown in FIG. 5. This biasing will cause the finger 77 of the locking pin 70 to reenter the locking notch 58 as soon as the locking pin 70 is in alignment with the locking notch 58. Thus, when the buttons 64 are no longer being pressed inward, the legs 62 are biased by the spring 80 to move horizontally outward. The horizontal outward motion of the legs 62 causes the locking pin 70 to move vertically downward, based on the corresponding retainer pins 76 moving along the angles of the corresponding angled holes 74, e.g., from the medial lowermost position to the lateral uppermost position. This vertical downward motion moves the extension of the finger 77 back into the locking notch 58, thereby immobilizing the tray 34 to prevent its rotation with respect to the arm 14. In this configuration, the assembly is returned to a transport condition.

In some aspects, the rotation of the tray 34 with respect to the arm 14 is restricted. In some aspects, the rotation is restricted to substantially 90 degrees of rotation, such that the longitudinal axis 40 of the tray 34 is orthogonal to the longitudinal axis 24 of the base 12, as shown in FIG. 3. Other ranges of motion could also be enabled, as could an aspect where rotation is not so restricted. For example, the rotation may be restricted to substantially 180 degrees of rotation relative to the bolt 38 that serves as the rotational axis, wherein the 180 degrees of rotation are substantially bisected by longitudinal axis 40. In such an example, a car seat having the assembly 10 herein allows for bidirectional rotation (e.g., clockwise and counterclockwise) relative to the longitudinal axis 40 which provides easy loading and unloading of a child into the car seat independent of whether the car seat is installed on a right or left side of a vehicle.

To restrict rotation of the tray 34, as the tray 34 rotates, the hub 46 rotates within the depression 52 and the round side wall 50 follows the perimeter of the round side wall 56 of the depression 52. At 90 degrees of rotation, the hub side wall 48 contacts the depression front wall 54, preventing further rotation. When a user rotates the tray 34 back, such that the longitudinal axis 40 aligns with the longitudinal axis 24, the finger 767 of the locking pin 70 will move into the locking notch 58 (such as through the biasing force of the spring(s) 80 acting on the legs 62). In aspects, where the circular end wall 50 of the hub 46 shaped and sized to rotationally move while following the perimeter formed by the round side wall 56, the angle formed between the opposing side walls 48, as measured relative to the bolt 38, may govern the available degrees of rotation. For example, when the opposing side walls 48 run parallel to one another, there is a greater available degree of rotation before the hub side wall 48 contacts the depression front wall 54, relative to an instance where the opposing side walls 48 are not parallel and form an angle (e.g., wherein the opposing side walls flare outward). Additionally, the combination of parallel opposing side walls 48 with the extension of the hub 46 to form the round side wall 50, provides for increased degrees of rotation while maintaining stability of the arm that supports the tray 34 in rotation, in particular, while load bearing.

In some aspects, as best seen in FIGS. 6 and 7, the arm 14 may include an upwardly extending retention bracket 82. As seen in FIG. 6, the bracket 82 may include a downwardly extending lip 84. The bracket 82 may be arcuate in shape. In some aspects, the bracket 82 is molded as part of the structure of the arm 14. In other aspects, all, or a portion of, the bracket 82 may include reinforcing elements, such as a metal. Correspondingly, the tray 34 may include an arcuate flange 86. As best seen in FIG. 6, the flange 86 rests below the bracket 82 (with the lip 84 extending over the flange 86) when the tray 34 is in the transport position of FIGS. 2 and 6. The interaction of the flange 86 and the bracket 82 aids in maintaining position of the tray 34 with respect to the arm 14.

Such a construction allows the rotation of the tray 34 with respect to the arm 14. Because the top surface 36 of the tray 34 may be carrying a car seat, this rotation allows a user to rotate the car seat installed on the tray 34 with respect to the arm 14 the base 12. As can be seen, the assembly 10 provides a more convenient base structure for the car seat and allows users additional orientation options for the car seat (installed on the tray 34) with respect to the base 12.

The following clauses provide example configurations of an assembly for securing a car seat within an automobile as disclosed herein.
Clause 1. An assembly for securing a car seat within an automobile, the assembly comprising: a base, the base having; a front, a back and a top area extending between the front and the back; the top area defining a channel nearer to the back than the front; an arm pivotally coupled to the base, the arm pivotal between a first position with the arm pivoted away from the top area allowing open access to the channel and a second position with the arm pivoted adjacent the top area preventing open access to the channel; and a tray rotatably coupled to a top surface of the arm, such that the tray is rotatable with respect to the arm, the tray having a top surface adapted to receive a car seat.
Clause 2. The assembly of clause 1, wherein the arm further comprises a locking notch defined in the top surface of the arm, and wherein the tray further comprises a pin moveable between a lowered position and a raised position, and wherein, when the tray is rotated to a transport position on the arm, the pin extends into the lowered position and into the locking notch.
Clause 3. The assembly of any of clauses 1-2, wherein the pin is biased to the lowered position.
Clause 4. The assembly of any of clauses 1-3, wherein the tray further comprises a release mechanism coupled to the tray and the pin, the release mechanism operable to move the pin from the lowered position to the raised position, wherein, in the raised position, the pin is disengaged from the locking notch such that the tray is rotatable with respect to the arm, the open indicia viewable through the viewing window when the cam is in the first position.
Clause 5. The assembly of any of clauses 1-4, wherein the arm is pivotally coupled to the base nearer to the back of the base than the front of the base.
Clause 6. The assembly of any of clauses 1-5, wherein the base and the arm each have a longitudinal axis extending in a direction from the back of the base to the front of the base, and wherein the tray has a front and a back, and wherein the tray has a longitudinal axis that aligns with the longitudinal axis of the base and the arm when the tray is in the transport position.
Clause 7. The assembly of any of clauses 1-6, wherein the tray has a protrusion with a first shape, and the arm has a depression with a second shape that accepts the protrusion on the tray, and wherein the rotation of the tray with respect to the base is limited by the interaction of the protrusion and the depression, such that the tray rotates until the longitudinal axis of the tray is orthogonal to the longitudinal axis of the arm.
Clause 8. The assembly of any of clauses 1-7, wherein the top area of the base defines at least one relief area, and wherein the arm has a bottom with at least one column extending therefrom, and wherein, when the arm is in the second position, the column is received within the relief area to align the arm with the base.
Clause 9. The assembly of any of clauses 1-8, wherein the release mechanism comprises: at least one push button moveable between an extended position and a depressed position, the button having a first end and a second end, wherein the second end engages with the pin as the button is moved from the extended position to the depressed position to move the pin to the raised position.
Clause 10. An assembly for securing a car seat within an automobile, the assembly comprising: an arm having pivot shoulders defining a pivot axis, the arm pivotal with respect to the pivot axis when coupled to a structure; and a tray rotatably coupled to a top surface of the arm, such that the tray is rotatable with respect to the arm, the tray having a top surface adapted to receive a car seat.
Clause 11. The assembly of clause 10, wherein the arm further comprises a locking notch defined in a top surface of the arm, and wherein the tray further comprises a pin moveable between a lowered position and a raised position, and wherein, when the tray is rotated to a transport position on the arm, the pin extends into the lowered position and into the locking notch, preventing rotation of the tray with respect to the arm.
Clause 12. The system of any of clauses 10-11, wherein the pin is biased to the lowered position.
Clause 13. The system of any of clauses 10-12, wherein the tray further comprises a release mechanism coupled to the tray and the pin, the release mechanism operable to move the pin from the lowered position to the raised position, wherein, in the raised position, the pin is disengaged from the locking notch such that the tray is rotatable with respect to the arm.
Clause 14. The system of any of clauses 10-13, wherein the tray has a protrusion with a first shape, and the arm has a depression with a second shape that accepts the protrusion on the tray, and wherein the rotation of the tray with respect to the base is limited by the interaction of the protrusion and the depression, such that the tray rotates until the longitudinal axis of the tray is orthogonal to the longitudinal axis of the arm.
Clause 15. A base assembly to secure a car seat within an automobile, the assembly comprising: a base having a front, a back and a top area extending between the front and the back; an arm pivotally coupled to the base, the arm pivotal between a first position with the arm pivoted away from the top area and a second position with the arm pivoted adjacent the top area; and a tray rotatably coupled to a top surface of the arm, such that the tray is rotatable with respect to the arm, the tray having a top surface adapted to releasably receive a car seat.
Clause 16. The base assembly of clause 15, further comprising a pin disposed on the arm and moveable between a locking position where the pin engages a portion of the arm and a release position where the pin is disengaged from the arm, and wherein the tray is rotatable with respect to the arm only when the pin is in the release position.
Clause 17. The base assembly of any of clauses 15-16, further comprising a release mechanism coupled to the tray and the pin, the release mechanism operable to move the pin from the locking position to the release position.
Clause 18. The base assembly of any of clauses 15-17, wherein the arm further comprises a locking notch defined in the top surface of the arm, and wherein the pin engages the locking notch when the pin is in the locking position and the tray is rotated to align the pin with the locking notch.
Clause 19. The base assembly of any of clauses 15-18, wherein the tray has a longitudinal axis and the arm has a longitudinal axis, and wherein the tray is in a transport position when the longitudinal axis of the tray is aligned with the longitudinal axis of the arm, and wherein, in the transport position, the pin is in the locking position.
Clause 20. The base assembly of any of clauses 15-19, wherein the tray is rotatable only to a degree such that the longitudinal axis of the tray is orthogonal to the longitudinal axis of the arm.

To assist and clarify the description of various embodiments, various terms are defined herein. Unless otherwise indicated, the following definitions apply throughout this specification (including the claims). Additionally, all references referred to are incorporated herein in their entirety.

“A”, “an”, “the”, “at least one”, and “one or more” are used interchangeably to indicate that at least one of the items is present. A plurality of such items may be present unless the context clearly indicates otherwise. All numerical values of parameters (e.g., of quantities or conditions) in this specification, unless otherwise indicated expressly or clearly in view of the context, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. Unless indicated otherwise, all measurements provided herein are taken when a component(s) is at standard ambient temperature and pressure (298.15 K and 100 kPa). As used herein, the terms “substantially” and “about” mean within ±5% of an indicated value. As used in the description and the accompanying claims, a value is considered to be “approximately” equal to a stated value if it is neither more than 5 percent greater than nor more than 5 percent less than the stated value. In addition, a disclosure of a range is to be understood as specifically disclosing all values and further divided ranges within the range.

The terms “comprising”, “including”, and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. The term “any of” is understood to include any possible combination of referenced claims of the appended claims, including “any one of” the referenced claims.

For consistency and convenience, directional adjectives may be employed throughout this detailed description corresponding to the illustrated embodiments. Those having ordinary skill in the art will recognize that terms such as “above”, “below”, “upward”, “downward”, “top”, “bottom”, etc., may be used descriptively relative to the figures, without representing limitations on the scope of the invention, as defined by the claims.

While various embodiments have been described, the description is intended to be exemplary, rather than limiting and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims.

While several modes for carrying out the many aspects of the present teachings have been described in detail, those familiar with the art to which these teachings relate will recognize various alternative aspects for practicing the present teachings that are within the scope of the appended claims. It is intended that all matter contained in the above description or shown in the accompanying drawings shall be interpreted as illustrative and exemplary of the entire range of alternative embodiments that an ordinarily skilled artisan would recognize as implied by, structurally and/or functionally equivalent to, or otherwise rendered obvious based upon the included content, and not as limited solely to those explicitly depicted and/or described embodiments.

What is claimed is:

1. An assembly for securing a car seat within an automobile, the assembly comprising:
a base, the base having;
a front, a back and a top area extending between the front and the back; the top area defining a channel nearer to the back than the front;
an arm pivotally coupled to the base, the arm pivotal between a first position with the arm pivoted away from the top area allowing open access to the channel and a second position with the arm pivoted adjacent the top area preventing open access to the channel; and
a tray rotatably coupled to a top surface of the arm, such that the tray is rotatable with respect to the arm, the tray having a top surface adapted to receive a car seat.

2. The assembly of claim 1, wherein the arm further comprises a locking notch defined in the top surface of the arm, and wherein the tray further comprises a pin moveable between a lowered position and a raised position, and wherein, when the tray is rotated to a transport position on the arm, the pin extends into the lowered position and into the locking notch.

3. The assembly of claim 2, wherein the pin is biased to the lowered position.

4. The assembly of claim 3, wherein the tray further comprises a release mechanism coupled to the tray and the pin, the release mechanism operable to move the pin from the lowered position to the raised position, wherein, in the raised position, the pin is disengaged from the locking notch such that the tray is rotatable with respect to the arm.

5. The assembly of claim 1, wherein the arm is pivotally coupled to the base nearer to the back of the base than the front of the base.

6. The assembly of claim 1, wherein the base and the arm each have a longitudinal axis extending in a direction from the back of the base to the front of the base, and wherein the tray has a front and a back, and wherein the tray has a longitudinal axis that aligns with the longitudinal axis of the base and the arm when the tray is in the transport position.

7. The assembly of claim 6, wherein the tray has a protrusion with a first shape, and the arm has a depression with a second shape that accepts the protrusion on the tray, and wherein the rotation of the tray with respect to the base is limited by the interaction of the protrusion and the depression, such that the tray rotates until the longitudinal axis of the tray is orthogonal to the longitudinal axis of the arm.

8. The assembly of claim 1, wherein the top area of the base defines at least one relief area, and wherein the arm has a bottom with at least one column extending therefrom, and wherein, when the arm is in the second position, the column is received within the relief area to align the arm with the base.

9. The assembly of claim 4, wherein the release mechanism comprises:
at least one push button moveable between an extended position and a depressed position, the button having a first end and a second end, wherein the second end engages with the pin as the button is moved from the extended position to the depressed position to move the pin to the raised position.

10. An assembly for securing a car seat within an automobile, the assembly comprising:
an arm having pivot shoulders defining a pivot axis, the arm pivotal with respect to the pivot axis when coupled to a structure; and
a tray rotatably coupled to a top surface of the arm, such that the tray is rotatable with respect to the arm, the tray having a top surface adapted to receive a car seat.

11. The assembly of claim 10, wherein the arm further comprises a locking notch defined in a top surface of the arm, and wherein the tray further comprises a pin moveable between a lowered position and a raised position, and wherein, when the tray is rotated to a transport position on the arm, the pin extends into the lowered position and into the locking notch, preventing rotation of the tray with respect to the arm.

12. The assembly of claim 11, wherein the pin is biased to the lowered position.

13. The assembly of claim 12, wherein the tray further comprises a release mechanism coupled to the tray and the pin, the release mechanism operable to move the pin from the lowered position to the raised position, wherein, in the raised position, the pin is disengaged from the locking notch such that the tray is rotatable with respect to the arm.

14. The assembly of claim 13, wherein the tray has a protrusion with a first shape, and the arm has a depression with a second shape that accepts the protrusion on the tray, and wherein the rotation of the tray with respect to the base is limited by the interaction of the protrusion and the depression, such that the tray rotates until the longitudinal axis of the tray is orthogonal to the longitudinal axis of the arm.

15. A base assembly to secure a car seat within an automobile, the assembly comprising:
a base having a front, a back and a top area extending between the front and the back;
an arm pivotally coupled to the base, the arm pivotal between a first position with the arm pivoted away from the top area and a second position with the arm pivoted adjacent the top area; and
a tray rotatably coupled to a top surface of the arm, such that the tray is rotatable with respect to the arm, the tray having a top surface adapted to releasably receive a car seat.

16. The base assembly of claim 15, further comprising a pin disposed on the arm and moveable between a locking position where the pin engages a portion of the arm and a release position where the pin is disengaged from the arm, and wherein the tray is rotatable with respect to the arm only when the pin is in the release position.

17. The base assembly of claim 16, further comprising a release mechanism coupled to the tray and the pin, the release mechanism operable to move the pin from the locking position to the release position.

18. The base assembly of claim 17, wherein the arm further comprises a locking notch defined in the top surface of the arm, and wherein the pin engages the locking notch when the pin is in the locking position and the tray is rotated to align the pin with the locking notch.

19. The assembly of claim 18, wherein the tray has a longitudinal axis and the arm has a longitudinal axis, and wherein the tray is in a transport position when the longitudinal axis of the tray is aligned with the longitudinal axis of the arm, and wherein, in the transport position, the pin is in the locking position.

20. The assembly of claim 19, wherein the tray is rotatable only to a degree such that the longitudinal axis of the tray is orthogonal to the longitudinal axis of the arm.
